(19) United States
(12) Patent Application Publication
(10) Pub. No.: US 2017/0313613 A1
(43) Pub. Date: Nov. 2, 2017

(54) FOREHEARTH AND BURNER BLOCKS FOR USE THEREIN

(71) Applicant: FIVES STEIN LIMITED, DIDCOT, OXFORDSHIRE (GB)

(72) Inventors: Peter MILSOM, Newbury (GB); Clive MORGAN, Abingdon (GB); Lee SULLIVAN, Didcot (GB)

(73) Assignee: FIVES STEIN LIMITED, DIDCOT, OXFORDSHIRE (GB)

(21) Appl. No.: 15/520,534

(22) PCT Filed: Oct. 21, 2015
(86) PCT No.: PCT/GB2015/053157

§ 371 Date: Apr. 20, 2017

(30) Foreign Application Priority Data
Oct. 21, 2014 (GB) 1418727.2

(51) Int. Cl. C03B 7/06

(52) U.S. Cl. CPC C03B 7/065

(57) ABSTRACT

Forehearth constructions are described in which means are provided to heat the sides of the stream of molten glass (27) passing along the forehearth from a glass-making furnace to one or more molten glass outlets by way of flames emerging from a series of substantially horizontal slots. The slots are located in the side walls of the channel above the level of the molten glass surface when the forehearth is operating, and the ribbon of flame provides improved heat transfer to the molten glass stream. Burner blocks are disclosed for use in constructing a forehearth of this type, each consisting of a block of refractory material having an internal cavity (3) of generally wedge-shaped construction and having an elongated outlet in. the form of a slot (4) in the face of the block. A combustible gaseous mixture, or the components to form a combustible gaseous mixture, are fed into the cavity remote from the slot.

This invention relates to forehearths and burner blocks for use in forehearth constructions.

A forehearth is a refractory-lined channel between a glass-making furnace in which the various components to make glass are heated to a high temperature and fused to form molten glass, and a number of outlets in the base of the channel at its end remote from the furnace via which molten glass may be fed to a forming machine, for example an independent section machine used for making glass bottles or jars, a bushing to produce fibre glass, a rolling machine to produce flat glass, a tin bath for float glass, or a mandrel for tubing.

It is important that the glass at the end of the forehearth is at the right temperature. It is also important that the temperature gradient within the glass at the end of the forehearth is relatively even so that the entirety of the glass is essentially at the same temperature and accordingly its viscosity does not vary and the products can be made simply and uniformly by the forming process.

The forehearth customarily consists of a refractory-lined channel along which the molten glass flows and of adequate length to enable homogeneity, particularly with respect to temperature, to be achieved at the discharge end remote from the glassmaking furnace. The channel is usually covered by a refractory-lined roof in order to enclose the flow of glass and to stop massive heat loss. Confining the stream of glass also enables its temperature to be adjusted by the use of burners above the surface of the molten glass.

Because of the loss of heat from the molten stream of glass to the refractory base and side walls of the forehearth, the glass adjacent the base and side walls is at a lower temperature, and substantially more viscous, than the glass at the centre of the stream of glass. Because the glass in the centre of the stream is less viscous it flows faster than the glass at the sides. It is known to promote a more even flow of the molten glass along the forehearth by cooling the centre of the stream of glass on the one hand and heating the sides and base of the stream on the other. A wide variety of heaters and burner and nozzle designs is known for achieving this. Many known systems are complex to control and some suffer from the additional disadvantage that they require a mixed fuel/air or fuel/oxygen-enriched air mixture to be fed from a position remote from the forehearth to e.g. a manifold and a set of individual nozzles at the end of which the mixture is ignited to form a heating flame.

Such arrangements are increasingly deemed unsatisfactory from the point of view of safety and it is highly desirable to have only very short piping runs where the piping contains an already combustible mixture. This is inconvenient where the fuel/air mixing equipment is located on the floor on which the forming machine is sited, since pipe runs need to be some length to reach the forehearth region which is, as noted above, above the top of the forming machine (which can be 4 or 5 metres high).

Safety concerns with respect to pipework containing a combustible mixture can be addressed by using burners in which the mixing of air or oxygen-enriched air and fuel takes place at a burner nozzle, but such nozzles tend to produce a long flame which leads to the disadvantage that the heating, which is desirably applied just to the sides of the stream of molten glass as it flows along the forehearth, actually extends to the centre of the stream, thus working counter to any cooling system which might be installed for cooling the centre of the flow, leading to a highly energy inefficient system.

In accordance with the present invention, there is provided a forehearth construction incorporating a channel between a glassmaking furnace and one or more outlets for molten glass through which a stream of molten glass flows in use, the forehearth construction including means to heat the sides of the stream of molten glass by way of flames emerging from a series of slots, each slot being substantially horizontal and where the slots are located in the side walls of the channel above the level of the molten glass surface when the forehearth is operating.

The present invention also provides bumer block constructions for use in constructing a forehearth of this type, each consisting of a block of refractory material having an internal chamber of generally wedge-shaped construction, and having an elongated outlet in the form of a slot in the face of the block, and means to feed a combustible gaseous mixture, or the components to form a combustible gaseous mixture, into a part of the chamber remote from the wall of the block in which the slot is located.

The preferred burner block is one which incorporates a mixing nozzle and means to connect the nozzle to supplies respectively of gaseous fuel and air or oxygen-enriched air. The nozzle introduces the gaseous combustion materials into the chamber where they mix and are expelled along the slot. The flow rate of the combustible components is usually adjusted so that combustion starts within the block, but adjacent the slot, from which a ribbon of flame emerges. This flame ribbon extends along the sides of the channel in the forehearth along which the molten glass flows.

Such a flame is generally flat in the horizontal plane, but the geometry of the side of the channel is preferably configured to encourage the flame to be drawn upwards to the underside of the forehearth roof. The flame travels along the roof resulting in a more efficient transfer of heat via convection and radiation to the roof block. The roof block then reradiates this heat to the glass surface.

The efficiency of heating the sides of the stream of molten glass as it flows through the forehearth as distinct from heating its centre may be improved by constructing the roof of the channel with two arched side sections running in the direction of the stream of molten glass passing along the forehearth and a central higher arched section above the centre of the stream of molten glass. The use of an arched roof section at the sides promotes a circulating flow of hot gases at each edge of the stream, promoting flow in a generally flattened circular path with the centre of the flattened circular path being located slightly below the level of the slot but above the surface of the molten glass.

Preferably the wall of the burner block below the slot is relieved, i.e. it slopes away from the stream of molten glass, which assists in enabling radiant heat from the burner block to heat the molten glass at the edges of the flow of glass passing along the forehearth.

The rear face of each burner block, i.e. the part opposite the face with the slot in it and which is thus on the outside of the forehearth construction, generally has an aperture in it in which the pipework and nozzle for carrying and distributing the combustible gas mixture is fitted.

By way of example, one embodiment of an improved burner block for use in a forehearth, and a forehearth construction using such blocks, is illustrated in the accompanying drawings in which:

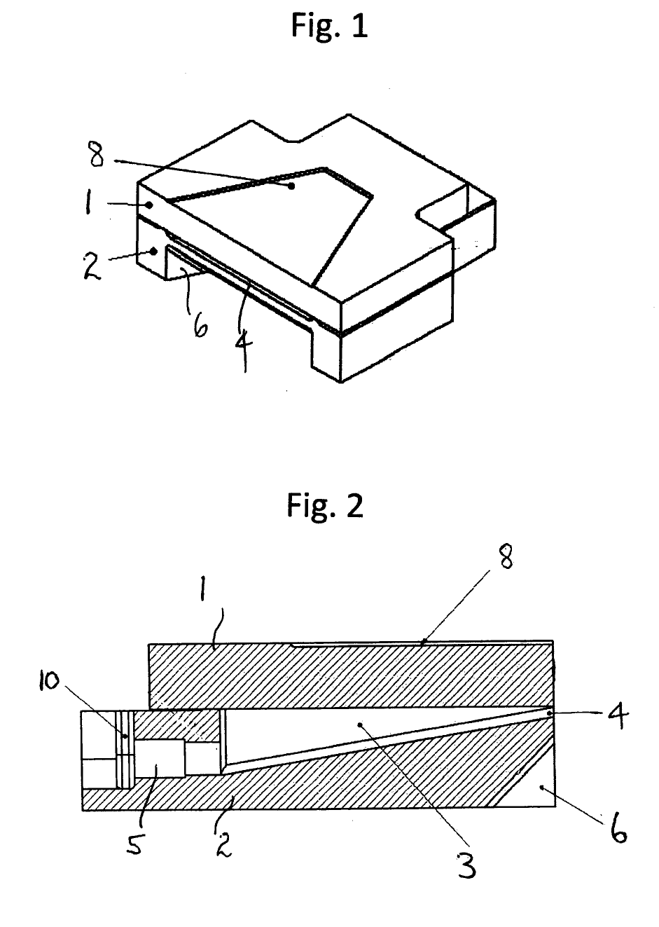

FIG. 1 is a perspective view of a burner block in accordance with the invention, seen from the side adjacent the molten glass stream in use;

FIG. 2 is a vertical section through the burner block of FIG. 1;

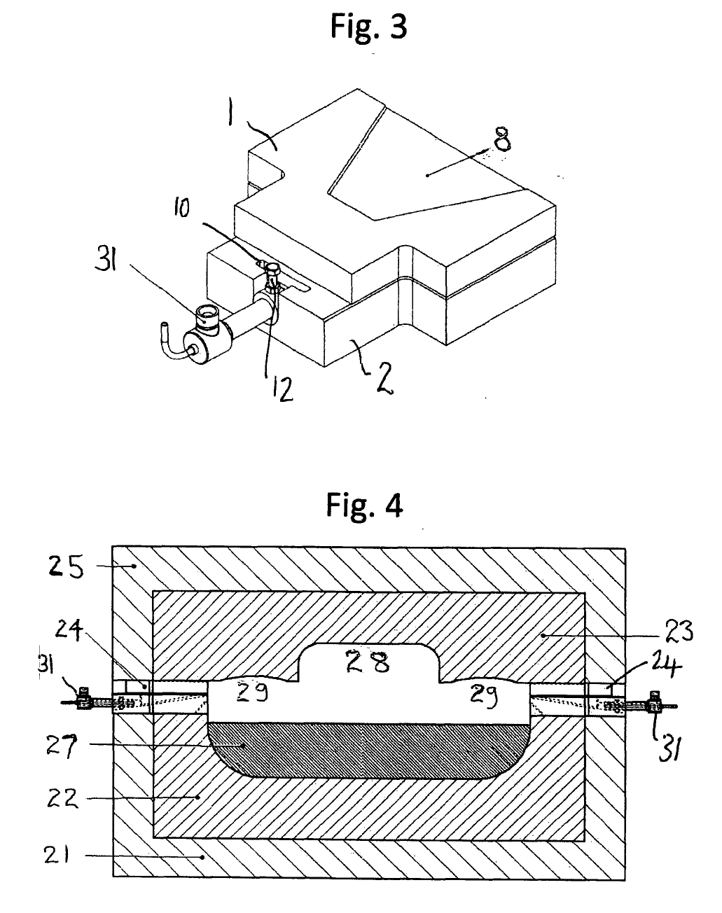

FIG. 3 is a perspective view of the burner block of FIG. 1 from the outside of the forehearth, showing a typical nozzle mix burner in place; and

FIG. 4 is a cross-section through a forehearth constructed in accordance with the present invention in operation.

Referring to FIGS. 1 to 3, a burner block in accordance with the invention is formed of upper and lower blocks of refractory material, for example sillimanite refractory. The upper block denoted 1 is of generally even thickness while the lower block 2 has a generally wedge-shaped chamber 3 formed in it. After moulding the two blocks, these can be set to a green state and then mortared together using a suitable refractory cement, before firing the burner block as a single piece. When the upper and lower blocks 1 and 2 are assembled together there is a narrow slot 4 formed at the edge of chamber 3. At the rear of the chamber 3 is a through hole 5 in which is located a feed pipelnozzle assembly 31 (FIG. 3).

As can be seen in FIGS. 1 and 3, the lower burner block half has a slot denoted 10 moulded into it. After the block has been fired, a bracket is slid into the slot 10. The portion of the bracket inside the slot 10 has a hole in it which aligns with the hole denoted 5 at the end of the chamber 3. A burner nozzle can now be inserted through the bracket with its head lying in through-hole 5 at its end towards the chamber 3. The nozzle may be fixed to the bracket by any convenient means, such as a locking screw 12 as shown in FIG. 3. The fixing locks the nozzle assembly 31, the bracket and the refractory burner block together.

The front face of the lower burner block half 2, below the slot 4 at the edge of chamber 3, is relieved, denoted 6 in FIGS. 1 and 2. The area at the top of the burner block half 1 has a relieved surface 8 a few millimetres deep, to direct the weight of the roof blocks, which rest on the burner blocks when assembled into a forehearth construction, through the solid sides of the burner block, with the object of preventing these forces from causing the slot 4 in the burner block face from closing over time during use of the forehearth.

The mounting of such burner blocks along the sides of the forehearth is shown in FIG. 4. This shows diagrammatically in cross-section a forehearth in accordance with the invention. The basic construction is of a steelwork frame (not shown) carrying an insulated base 21 with a channel block 22 along which molten glass 27 flows in use. To either side is a series of burner blocks 24 in accordance with the invention. The burner blocks 24 support roof members 23. An insulative layer of suitable material 25 covers the assembly of burner blocks 24 and roof members 23.

A suitable arrangement of supply piping to the feed pipe/nozzle assemblies 31 set in the line of blocks 24 on each side of the forehearth is provided in order to feed the gas and air or oxygen-enhanced air to each of the nozzles.

Appropriate flow control means can be provided in customary fashion between supplies of gas, air and, if further oxygen is required, oxygen. These can all be located satisfactorily away from the forehearth itself to ensure ease of maintenance and suitable ambient conditions.

In operation, fuel and air or oxygen-enriched air are fed through the nozzle into the end of chamber 3 remote from the slot 4, and combustion starts inside the chamber and the combusting gaseous mixture then accelerates as the flow moves towards the slot due to the narrowing of the cross-section of the chamber towards the slot 4. A generally flat flame emerges from the slot 4 along the entire width of the block, which flame then (because the slotted burner blocks are located along the sides of the molten glass stream denoted 27 in FIG. 4) extends along the sides of the forehearth and heats the underside of the roof block which radiates heat down to the molten glass, predominantly towards the edges of the stream of molten glass. This is provided by the shaping of the underside of the roof members 23, with two lower arched sections 29 either side of a higher central arched section 28.

A specific advantage of the flat flame is that it gives a very even distribution of heat across the block and, accordingly, the heat transmitted to the glass at the sides of the stream of glass flowing along the forehearth is also even so there is very little risk of so-called re-boil of the glass surface. The relieved section 6 below the slot 4 assists in heating the molten glass 27 at the edges of the flowing stream.

It should be noted that the nozzle does not require any igniter or the like located at the end from which the combustible mixture emerges; rather, because of the temperature in the forehearth, the combustible mixture will ignite within the burner block chamber 3.

1-6. (canceled)

7. A forehearth construction comprising a molten glass channel between a glass-making furnace and one or more outlets through which a stream of molten glass flows in use, wherein the sides of the stream of molten glass are heated by way of flames emerging from a series of slots, each slot being substantially horizontal and where the slots are located in the side walls of the channel above the level of the molten glass surface when the forehearth is operating.

8. The forehearth construction according to claim 1 further comprising a roof over the channel, the roof having two arched side sections running in the direction of the stream of molten glass passing along the forehearth and a central higher arched section above the centre of the stream of molten glass.

9. A burner block construction for use in constructing a forehearth according to claim 7 comprising a plurality of blocks of refractory material, each having an internal chamber of generally wedge-shaped construction, and having an elongated outlet in the form of a slot in the face of the block, and supply piping to feed a combustible gaseous mixture, or the components to form a combustible gaseous mixture, into part of the chamber remote from the wall of the block in which the slot is located.

10. The burner block construction according to claim 9 wherein each block incorporates a mixing nozzle connected to supplies of one of more of gaseous fuel, air, oxygen-enriched air, or oxygen.

11. The burner block construction according to claim 9 wherein the wall of each burner block below the slot is relieved so that it slopes away from the stream of molten glass passing along the forehearth.

12. The burner block construction according to claim 10 wherein the rear face of each burner block, which is opposite the face with the slot in it and which lies on the outside of the forehearth construction, has an aperture in it in which the supply piping and nozzle for carrying and distributing the combustible gas mixture is fitted.
